(19) United States
(12) Patent Application Publication
(10) Pub. No.: US 2009/0257309 A1
(43) Pub. Date: Oct. 15, 2009

(54) METHODS AND SYSTEMS FOR SEISMIC EVENT DETECTION

(76) Inventor: J. Theodore CHERRY, Licking, MO (US)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/480,672

(22) Filed: Jun. 8, 2009

Related U.S. Application Data
(62) Division of application No. 12/120,800, filed on May 15, 2008.
(60) Provisional application No. 60/924,546, filed on May 18, 2007.
(60) Provisional application No. 60/935,453, filed on Aug. 14, 2007.
(60) Provisional application No. 60/984,245, filed on Oct. 31, 2007.

(51) Int. Cl. G01V 1/22; G01V 1/00

(52) U.S. Cl. 367/77; 367/57

(57) ABSTRACT

The invention is directed to a system for detecting seismic waves. The system has one or more sensor modules. Each sensor module has a detection unit, a positioning module, a digitizer, a radio transmitter, and a power supply. The system also includes a communications interface including a receiver, a data storage device, and a data relay module, and a data processor. The system may be used to detect seismic events by positioning sensor modules in an area, positioning a communications interface module in an area, establishing communication, polling the sensor modules for data, and relaying the data. The polling and relaying may be repeated at predetermined time intervals. Then, analysis may be performed on the data, and the seismic event may be identified as a precursor.

### CROSS-REFERENCE TO RELATED APPLICATIONS

The present application claims priority to and is a divisional application of patent application Ser. No. 12/120,800, filed on May 15, 2008, which application claims the benefit of the provisional application entitled “METHODS AND SYSTEMS FOR SEISMIC EVENT DETECTION,” Provisional Patent Application No. 60/924,546, filed on May 18, 2007, the provisional application entitled “METHODS AND SYSTEMS FOR SEISMIC EVENT PREDICTION,” Provisional Patent Application No. 60/935,453, filed on Aug. 14, 2007, and the provisional application entitled “INSTANTANEOUS SEISMIC EVENT PREDICTION AND DETECTION,” Provisional Patent Application No. 60/984,245, filed on Oct. 31, 2007. The disclosures of each of patent application Ser. No. 12/120,800 and Provisional Patent Application Nos. 60/924,546, 60/935,453, and 60/984,245, are incorporated herein by reference in their entirety.

### BACKGROUND OF THE INVENTION

1. Field of the Invention

The invention relates generally to systems for detecting seismic movements and methods for employing such seismic detection systems. In particular, the invention is related to seismic event detection systems which detect waves and wave movements resulting from underground activity, both natural, e.g., earthquakes and earthquake precursors, and man-made, e.g., digging, tunneling, blasting, or other disruptive events, both above and under ground. The invention further relates to methods for deploying such systems, and methods for using such systems in a predictive manner to forecast seismic events.

2. Description of Related Art

It is useful to obtain information about events taking place underground, without digging into or otherwise directly observing the underground area. By obtaining information about events taking place underground, walls or barriers may be more effectively positioned to ward against intruders, and people or animals trapped underground may be more readily located.

Known seismic event detection systems and seismic event prediction systems may detect earthquakes and other natural and man made underground disturbances and activity. Nevertheless, these known systems may require significant resources for deployment. Known systems may use fixed detection units, and may place or dispose the detection unit, or at least a sensor, in a borehole. Consequently, these known systems may take weeks or months, or even longer, to install, move, and remove, and may cause significant disruption to the areas in which they are placed or disposed. Known, stationary systems also may be subject to degradation, damage, or destruction, by causes both natural and otherwise. Additionally, known, seismic event detection systems may require significant knowledge of the potential deployment site, and also may require that significant site infrastructure be established before deployment.

Known systems may be designed primarily to detect significant seismic events, such as earthquakes and other underground or undersea disturbances. These systems may be inadequate, however, for detecting more localized seismic events, such as tunneling, mining, or other underground activity. Such systems including known sensors or sensor arrays may not be capable of detecting this level of activity, nor of filtering enough of the noise from the significant signals. Further, known systems intentionally may filter out signals below a predetermined amplitude or frequency in order to obtain a clearer identification and measurement for seismic events of a predetermined magnitude. Thus, more localized seismic events, or seismic events of a lower magnitude, may be considered too difficult to detect, or unworthy of detection.

For example, known systems for detecting underground tunneling may be inadequate for accurate detection, because by the time such a system is designed and deployed, the tunnel may be completed, or rerouted to a place that may be beyond the range of the deployed unit, thus frustrating the unit's purpose. Further, it may not be cost-effective to move such systems from location to location, because known systems may rely on static sensor sites in order to obtain measurements. Thus, known systems may be inadequate to detect dynamic, but localized, seismic events originating from man-made sources.

Other known systems may attempt to use infrared or thermal technologies to detect seismic events. Nevertheless, these systems may give false readings when subjected to various cloaking and stealth procedures. These systems also may require significant amounts of manpower and resources in order to be deployed properly and to perform adequately, and, even then, their performance may not be consistent or reliable.

Further, it is useful to predict the occurrence of seismic events, such as earthquakes. Known systems may detect gravitational field turbulence or low frequency radio signals about twenty (20) seconds prior to an arrival of the earthquake, but currently do not predict earthquakes far enough in advance to allow measures to be taken to minimize potential damage or to permit effective evacuation, or both.

### SUMMARY OF THE INVENTION

Therefore, a need has arisen for seismic event detection systems and methods of employing such seismic event detection systems that overcome these and other shortcomings of related art systems and methods. A technical advantage of embodiments of the present invention is that the seismic event detection systems may be wholly or substantially portable, implanted or positioned quickly, efficiently, and, if necessary, covertly, and are adaptable to changing needs and conditions. Further, these systems may detect precursors, which may be lower in magnitude than the seismic events that succeed them. An earthquake precursor may be a seismic event or series of related events that appear and are detectable prior to a larger scale seismic event, e.g., an earthquake. A precursor may be identified by searching for seismic events having similar fundamental characteristics to larger seismic events. By detecting, measuring, and analyzing these precursors, the location and magnitude of earthquakes may be predicted in advance.

In an embodiment of the invention, a system for detecting seismic waves comprises one or more sensor modules. Each sensor module comprises a detection unit configured to detect a plurality of seismic waves generated by seismic events, a positioning module, configured to determine the position of the sensor module, a digitizer configured to communicate with the detection unit, a radio transmitter configured to transmit digital data collected by the digitizer, and a power supply configured to provide power to the sensor module. The system also comprises a communications interface module. The communications interface module comprises a receiver configured to receive digitized data from the plurality of sensor modules, a data storage device configured to store the received digitized data, and a data relay module configured to transmit the received digitized data. The system also comprises a data processor configured to receive the data transmitted from the communications interface module, wherein the plurality of sensor modules, the communications interface module, and the data processor are configured to function independently of their position, and to change positions independently of each other.

In another embodiment of the invention, a method of detecting seismic events comprises positioning a plurality of sensor modules in a target area, positioning a portable communications interface module within a predetermined range of the plurality of sensor modules, establishing communication between the portable communications interface module, and the plurality of sensor modules, remotely configuring the portable communications interface module using a data processor, polling each of the plurality of sensor modules for signal data using the portable communications interface module, collecting the signal data with the portable communications interface device, relaying the signal data from the portable communications interface device to the data processor, performing analysis on the relayed signal data, and displaying the relayed signal data.

In yet another embodiment of the invention, a method of detecting seismic events comprises positioning a plurality of sensor modules in an area, positioning a communications interface module within a predetermined range of at least one of the plurality of sensor modules, establishing a radio connection between the communications interface module, and at least one of the plurality of sensor modules, remotely configuring the communications interface module using a data processor, polling each of the plurality of the sensor modules for signal data using the communications interface module, relaying the signal data received by the plurality of sensor modules to the data processor, repeating the polling and relaying steps at predetermined time intervals to generate time-based signal data, calculating one or more characteristics of the time-based signal data captured by at least one of the plurality of sensor modules, using the time-based signal data, comparing at least one of the characteristics to a set of known characteristics previously collected, and determining if the signal data is generated by a precursor.

In still another embodiment of the invention, a method of detecting a seismic event comprises collecting data from a plurality of sensor arrays, wherein each array comprises one or more sensor modules, each sensor array positioned at a different location and configured to detect a plurality of seismic waves generated by seismic events, transmitting data from each array to a data processing module, calculating, for each sensor array, a horizontal phase velocity of the seismic waves detected at the sensor array, determining an azimuth of the seismic waves for each horizontal phase velocity calculated, using the collected data from each sensor array, calculating an origin of the seismic event generating the seismic waves, based on determined azimuths of the event, the horizontal phase velocities, and the collected data, comparing the horizontal phase velocity and the azimuth of the seismic waves with a predetermined horizontal phase velocity and a predetermined azimuth, wherein the predetermined horizontal phase velocity and the predetermined azimuth are calculated from previous seismic event detections of a predetermined type, and identifying the seismic event as a precursor to a seismic event having similar characteristics but greater energy than the precursor.

Other objects, features, and advantages will be apparent to persons of ordinary skill in the art from the following detailed description of the invention and the accompanying drawings.

### BRIEF DESCRIPTION OF THE DRAWINGS

For a more complete understanding of the present invention, the needs satisfied thereby, and the objects, features, and advantages thereof, reference now is made to the following descriptions taken in connection with the accompanying drawings.

FIG. 1 is a schematic of a system for detecting seismic events according to an embodiment of the present invention.

FIG. 2 is a schematic of sensor modules as part of a system for detecting seismic events according to an embodiment of the present invention

FIG. 3 is a schematic of a communications interface module as part of a system for detecting seismic events according to an embodiment of the present invention

FIG. 4 is a flowchart of a method for using a system, e.g., the system shown in FIG. 1, to collect signal data, according to another embodiment of the present invention.

FIG. 5 is a graphical representation of a plane wave vector calculated by an embodiment of the invention.

FIG. 6 is a graphical representation of data captured during a major seismic event according to an embodiment of the invention.

FIG. 7 is a graphical representation of data captured during a first precursor to the seismic event depicted in FIG. 6.

FIG. 8 is a graphical representation of data captured during a second precursor to the seismic event depicted in FIG. 6.

FIG. 9 is a flowchart of a method for identifying precursors according to an embodiment of the invention.

FIG. 10 is a flowchart of a method for identifying seismic events based on the generated signal data according to an embodiment of the invention.

### DETAILED DESCRIPTION OF PREFERRED EMBODIMENTS

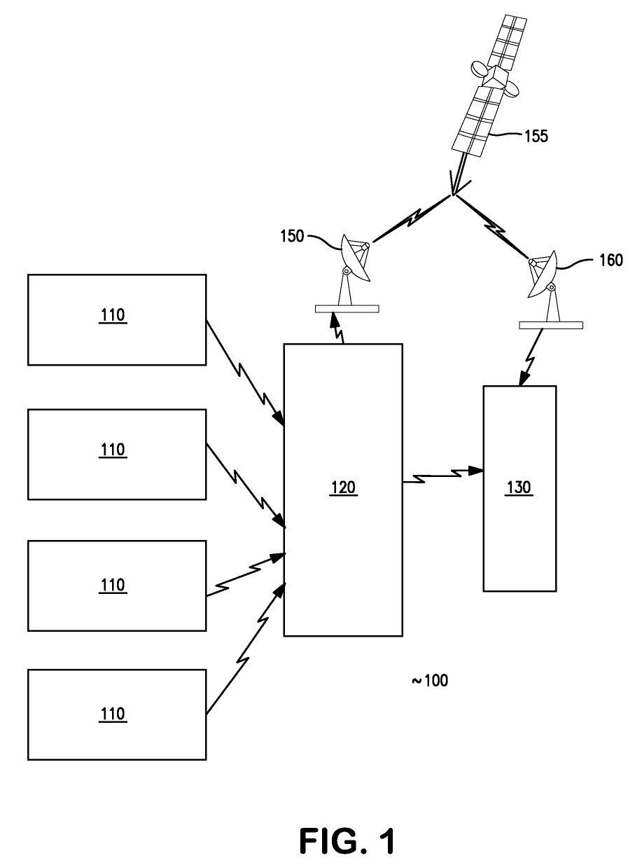

Preferred embodiments of the present invention and their advantages may be understood by referring to FIGS. 1-10, like numerals being used for like corresponding parts in the various drawings.

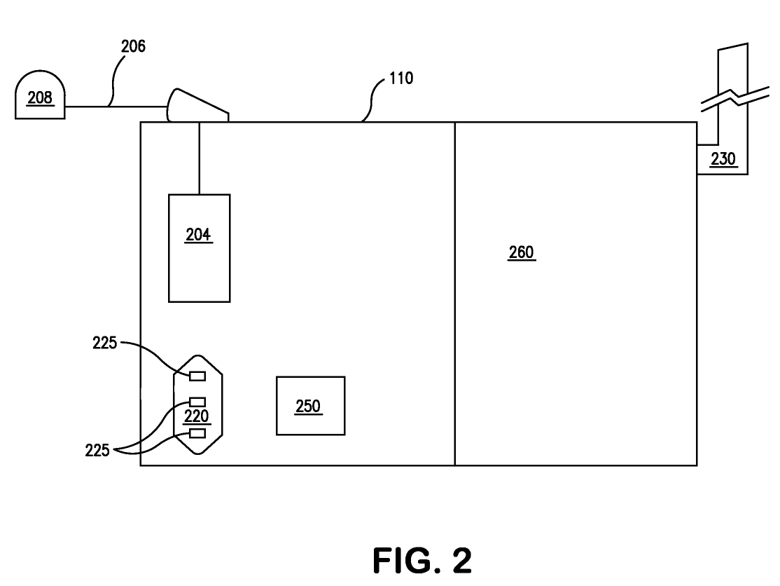

Referring to FIG. 1, a system 100 for detecting seismic events may comprise a plurality of sensor modules, e.g., seismic sensors including seismometers, infrasound sensors, hydroacoustic sensors, or other sensors. In an embodiment of the invention, between two (2) and about twenty (20) sensor modules 110 (described herein with respect to FIG. 2) may be incorporated into the system. Nevertheless, a single sensor could be used at a single site. In an embodiment of the invention, four (4) sensor modules 110 provide sufficient data to extrapolate meaningful results, without overloading the system with data points. System 100 also may comprise a communications interface module, e.g., communications interface module 120. In an embodiment described herein, communications interface module 120 may be a portable module, and the system may operate independently of the position of the communications interface module Nevertheless, the communications interface module could be implemented as a stationary piece of equipment at a stationary site, e.g., in a building or other structure.

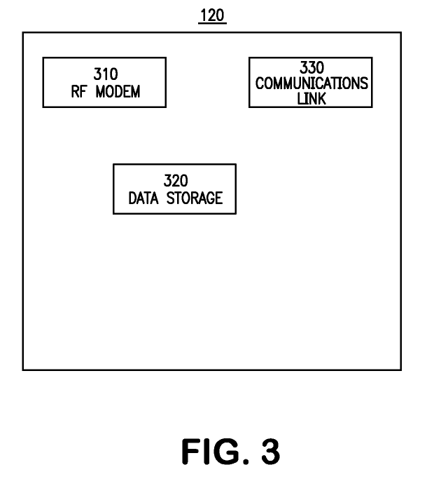

Communications interface module 120 (described herein in more detail with respect to FIG. 3) may receive seismic, hydroacoustic, or infrasound wave data transferred from the plurality of sensor modules 110. The wave data may be collected, formatted, and forwarded to a data processing module, e.g., data processing module 130. In an embodiment described herein, data processing module 130 may be a portable module, e.g., a laptop computer, or another data processing device. Nevertheless, data processing module 130 also may be implemented as a stationary device, e.g., a desktop or mainframe computer. If communications interface module 120 is unable to establish a communications link with data processing module 130, communications interface module 120 then may be configured to archive, e.g., store, received data in an onboard memory storage device.

As noted above, portable data processing module 130 may comprise a laptop computer and may have varying specifications and capabilities. For example, portable data processing module 130 may be configured to connect to the Internet, and may comprise a processor, an input device, an output device, and a data storage device. Data processing module 130 also may be configured to run a suitable operating system, e.g., UNIX, LINUX, Microsoft Windows, or the like. In addition, portable data processing module 130 may be powered by a portable power source, e.g., a rechargeable battery or plurality of batteries, or may be powered by AC outlet power, where available. Data processing module 130 may remotely configure communications interface module 120, e.g., through a LAN, network, Internet interface, or the like. Data processing module 130 may be a dedicated module designed for the purpose of storing data relayed from the communications interface module 120, or data processing module 130 may be implemented in any portable computer, e.g., a laptop computer, capable of connecting to a LAN, network, Internet interface, or the like, executing the software applications for controlling the communications interface module 120, and receiving data and storing the received data.

If data processing module 130 is not sufficiently proximate to communications interface module 120 to transmit, communications interface module 120 may send data to a remote communications relay device or station, such as a satellite communications station, which then may relay the data to data processing module 130. This configuration may increase the potential data transmission range, and allow data processing module 130 to be located remotely to communications interface module 120 and the sensor module 110, as the application may require.

Data processing module 130 may receive combined wave data from communications interface module 120. The data then may be processed, archived, and displayed in real-time. The processed data may be displayed on-screen in one or more graphical formats, including visual representations of the data, e.g., maps, charts, graphs, tables, or the like.

After data processing module 130 has received and processed the data, data processing module 130 may perform analysis of the data, including data extrapolation, data interpolation, other statistical methods, or the like. One purpose of this analysis may be to identify the cause of the seismic event which generated the data. Another purpose of the analysis may be to predict further seismic events which may have similar characteristics. A further purpose of the analysis also may be to pinpoint the location at which the seismic event started. Data processing module 130 may use a variety of other information in analyzing the collected data. For example, previously recorded field results, previously recorded testing results, data extrapolation techniques, artificial intelligence techniques, or the like, may be used to determine a cause of the seismic event generating the received signal data. The analysis performed by data processing module 130 may be sent to the user, where the determination may be evaluated or otherwise acted upon.

Each sensor module 110 may be housed in a housing sealed against the environment, e.g., water-resistant, weather-resistant, and debris-resistant housing. The housing may comprise a sturdy, lightweight material, e.g., aluminum. As shown in FIG. 2, each sensor module 110 may comprise a plurality of sensor units 220. Sensor units 220 may have multiple configurations, including a triaxial configuration, as shown in the figures, or a vertical configuration (not shown). A full system may incorporate different numbers of triaxial, vertical, or other configurations of sensors. As shown in FIG. 2, sensor unit 220 may comprise a plurality of sensors, e.g., seismometers 225 (shown schematically). Although other configurations may be used, the sensor depicted may arrange the sensors in a triaxial fashion, e.g., adapted to detect movements in three (3) axes, e.g., an x-direction, a y-direction, and a z-direction, sensor unit 220 may detect seismic wave movements generated by localized seismic events, such as tunneling and underground activity, in any direction.

Sensor unit 220 may be configured to record seismic wave movements having frequencies between about 0.04 Hz and about 100 Hz, and Root Mean Square (“RMS”) amplitudes ranging from zero to about 10 m/s². In an embodiment of the present invention, sensor module 110 also may comprise a filter or series of filters (not shown) for filtering out signals generated by secondary wave movements resulting from seismic waves which reverberate underground, e.g., through the Earth's crust. These secondary wave signals, which may be unwanted in some calculations, may have wave characteristics that are different from the wave characteristics of the desired localized signals, thus allowing the unwanted signals to be filtered by the sensor module 110.

Each sensor module 110 also may comprise at least one Global Positioning System transceiver 204. GPS transceiver 204 may be connected via a GPS cable 206 to an antenna, e.g., micropatch antenna 208. Micropatch antenna 208 allows GPS transceiver 204 to maintain line-of-sight communication with the GPS satellite system (not pictured), even if sensor module 110 is buried underground or otherwise concealed in a manner such that the body of sensor module 110 may not comprise line-of-sight with the GPS satellite system. Micropatch antenna 208 may be made of magnetic material for affixing to metallic surfaces.

Sensor module 110 also may comprise a digitizer 250. Digitizer 250 may receive raw data from sensor unit 220 and may convert the analog data into digital sample data, ready to be transmitted. Sensor module 110 also may include an RF antenna 230 for transmitting the digitized data. In an embodiment of the present invention, RF antenna 230 may be a 24 cm wave dipole, with an articulating right angle whip, however, other antennas suitable for transmission may be substituted. RF antenna 230 may be removable and interchangeable with other antennas based upon the expected use of the sensor module 220.

Sensor module 110 also may comprise a battery pack cavity 260 into which a battery pack (not shown) may be inserted. The battery pack may be detachable from sensor module 110 to allow for replacement or recharging of the power supply. The battery pack may comprise any of a plurality of types of batteries, including rechargeable and disposable batteries. In an embodiment of the invention, one or more lithium-thionyl chloride (Li—SOCl₂) batteries may be used in a battery pack. The battery pack may be affixed to battery pack cavity 260 by a known fastening device, e.g., clasps, clips, a plurality of screws, nuts and bolts, or the like. In still another embodiment of the present invention, a solar energy panel may be used to charge the battery pack while the unit is functioning in the field.

Communications interface module 120 may be housed in an environmentally secure housing, e.g., a waterproof, weatherproof, and debris-resistant housing. The housing may comprise any sturdy, lightweight material, e.g., aluminum. As shown in FIG. 3, communications interface module 120 may comprise an RF modem 310, which may poll the sensor modules 110 that are within a predetermined range, and may collect signal data from the sensor modules 110. As data is received by RF modem 310, the data may be buffered in data storage module 320, and may be transferred to data transmitting module 330. Data transmitting module 330 may transfer data to the data processing module 130. The data may be transferred via a direct cable connection or broadcast over an Internet, satellite communications, or other suitable link. If data is not transferred directly from communications interface module 120 to data processing module 130, then, as shown in FIG. 1, the data may be sent to a remote transmitter, e.g., a satellite transmitter 150, which may transmit the data to satellite 155. Satellite 155 then may transmit the data to satellite receiver 160, which then may relay the data to data processing module 130. Communications interface module 120 may be provided with network connectors for various telecommunications cabling, e.g., Ethernet RJ-45 cables, optical fiber cables, coaxial cables, or the like, and also may be adapted to transmit the data wirelessly.

Communications interface module 120 may detect the status of the communications link between communications interface module 120 and data processing module 130. When communications interface module 120 detects that the communications link has been disrupted or otherwise interfered with, communications interface module 120 may store the incoming signal data in data storage module 320. Data storage module 320 may be any suitable memory device capable of storing digital data, including flash memory, digital storage disks, hard disk drives, optical drives, tape drives, or the like. In and embodiment of the present invention, a flash memory device may be used as data storage module 320, in order to reduce power usage and physical space within the unit.

While the amount of time for which communications interface module 120 may store data may have no theoretical operational limit, in an embodiment of the present invention, communications interface module 120 may comprise sufficient memory storage to store data for a period of two weeks. While signal data resides in memory storage in portable communications interface 120, communications interface module 120 may attempt to establish communications with data processing module 130 continuously, or at predetermined intervals, or at one or more predetermined times, until a connection is made.

Data may be sent by communications interface module 120 by one or more data protocols. In one embodiment of the present invention, Advanced Data Communication Control Protocol (ADCCP) is used to transmit the data. Nevertheless, Synchronous Data Link Control (SLDC), High-level Data Link Control (HDLC), or other suitable protocols may be used to transmit the data. Data may be encrypted using a known encryption system, e.g., a public-key or a private-key system.

In an embodiment of the invention, communications interface module 120 may receive configuration data from data processing module 130. When a communications link has been established between communications interface module 120 and data processing module 130, data processing module 130 may transmit configuration data to communications interface module 120. Such configuration data may comprise the buffer size, the frequency with which data is sent, the number of sensor units that may send data at the same time, whether to enter diagnostic mode, and the level of logging and error checking to be performed.

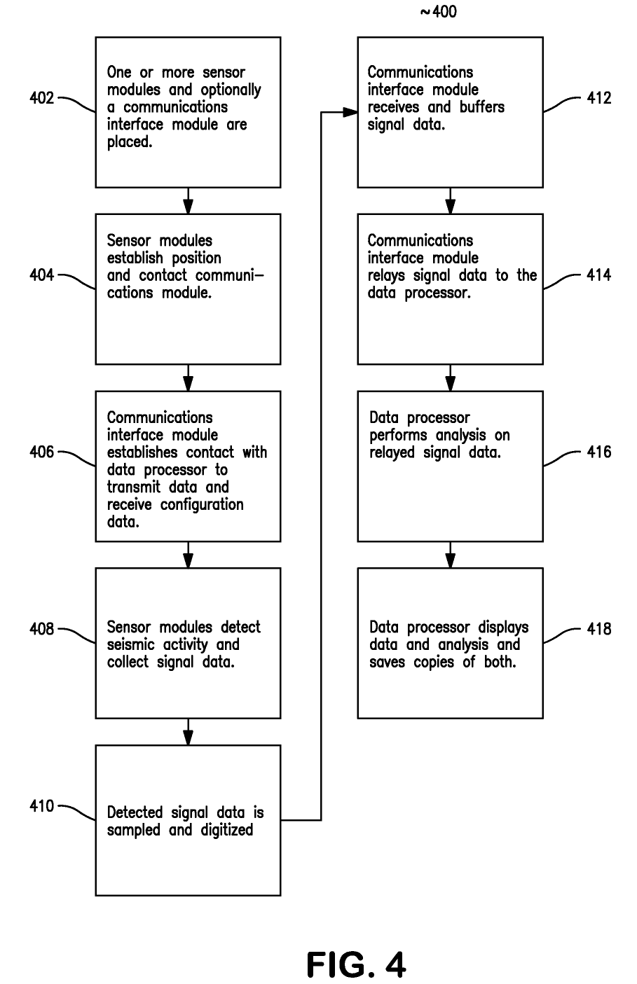

Referring to FIG. 4, a method 400 of detecting seismic activity according to an embodiment of the invention is described. In step 402, one or more sensor modules 110 may be positioned in a target area, e.g., an area of potential seismic activity, either resting on the ground, buried a predetermined depth, or both. Additionally, communications interface module 120 also may be positioned in range of the one or more sensor modules 110. In step 404, positioned sensor modules 110 may use their onboard GPS transponders 204 in order to retrieve information about their positions. The depth at which the sensors are placed may be self-calibrated using the GPS positioning system, and the depth does not necessarily affect the accuracy of the readings. Also at step 404, the placed sensor modules 110 may establish communications with the communications interface module 120, via any known communications method.

In step 406, the communications interface may establish communications with a data processing station, e.g., data processing module 130. The communications interface also could establish communications with a stationary data processing station, if one is within range. In step 408, sensor units 220 within sensor module 110 may detect seismic activity caused by events occurring underground which may trigger seismic wave movements in proximity to the one or more sensor modules 110. As the seismic activity occurs, signal data associated with the seismic activity may be collected.

In step 410, the detected signal data may be sampled and digitized by digitizer 250. The digitized signal may be transmitted to the communications interface module 120, which may be a predetermined distance, e.g. from zero to about thirty-five (45) kilometers line-of-sight away from one or more positioned sensor modules 110. In step 412, communications interface module 120 may receive the digitized data from the one or more sensor modules 110, storing the digitized data in data storage module 320. In step 414, the buffered data may be transmitted to data processing module 130. If communications interface module 120 does not successfully establish a connection with data processing module 130, then the collected data may be stored in data storage module 320 until a connection is established.

In step 416, data processing module 130 may receive the data from communications interface module 120, and data processing module 130 may perform analysis on the data, and display the data, and the results of the analysis, or both, in real-time, or quasi real-time, e.g., once a second. The data may be displayed in a plurality of formats, which may depend on a variety of factors, e.g., user preferences and system specifications. In step 418, data processing module 130 may use the received data and the results of the analysis to display the received data in a variety of forms, e.g., graph form, table format, pictoral format, chart format, or the like.

In an embodiment of the invention, data processing module 130 may analyze the signal data and generate a plane wave. This plane wave may be displayed as a beam on a slowness grid, with the grid indicating the beam amplitude and the specific beam vector.

Based on the data received, and optionally using data previously collected by sensor modules 110 and other sensor modules, data processing module 130 may predict the type of event that may be generating the seismic waves. Data processing module 130 also may use the data received and the previously collected data to determine if the event is a precursor, e.g., a seismic event with similar characteristics to a larger seismic event, and which may be used to predict the larger seismic event. Precursors and precursor identification are described in more detail herein.

Although FIG. 4 describes the use of the seismic wave detection and prediction system using portable modules, the process described in FIG. 4 also may be carried out using stationary arrays and data processing modules, such as those described in U.S. Pat. No. 7,196,634, the disclosure of which is incorporated herein by reference.

In another embodiment of the invention, sensor modules 110 may be placed in an array, either standing alone or in conjunction with stationary sensor modules. The sensor modules may be configured to detect precursors, e.g., seismic events indicative of larger seismic events, e.g., earthquakes. When a seismic event occurs, the seismic event generates P-waves, or primary waves. These waves are longitudinal waves which may propagate very quickly. Some seismic events also may produce S-waves, or secondary waves. These waves are transverse waves which may be very destructive to Earth's surface. Generally, the S-wave is the wave colloquially referred to as the “earthquake” or other seismic event. Nevertheless, seismic events may not produce S-waves, or may produce S-waves that may not propagate all the way to Earth's surface, or produce S-waves which may not be measurable at or near Earth's surface. Some seismic events may have a P-wave having the same or similar characteristics as the P-wave of an earthquake. Such P-waves may be called “precursors,” and their detection may indicate that an earthquake may occur at that location in a short amount of time, e.g., less than a day.

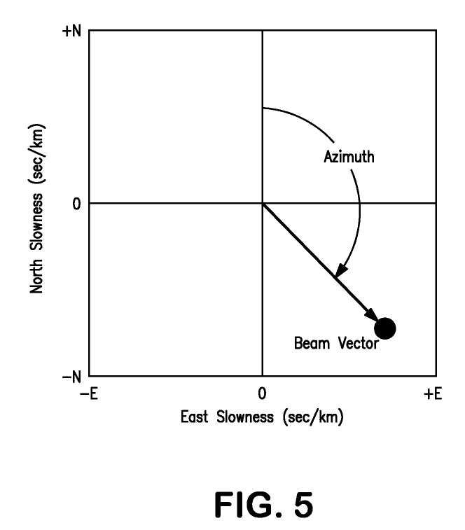

Sensor modules 110 may be configured to detect seismic energy from both P-waves and S-waves at predetermined intervals, and to transmit time-based seismic data to communications module, e.g., communications module 120, or may be configured to transmit directly to a data collection station. The receiving station may be a stationary data collection station, or it may be a portable data collection station, e.g., data processing module 130. Using this time-based seismic data, the data collection station may extrapolate a plane wave, based on an azimuth, arrival time, and a horizontal phase velocity of the waves. This plane wave may be represented by a beam, or a beam vector on a slowness grid, as shown in FIG. 5. Data processing module 130 then may compare one or more characteristics of the extrapolated plane waves to known, previously recorded plane waves, generated by seismic events in a similar area, which seismic events also generated destructive S-waves.

By extrapolating plane waves which have similar characteristics to the P-waves of earthquakes or other seismic events of similar magnitude, data processing module 130 may locate precursors. Then, the receiving station may predict the arrival time and location of larger seismic events based on the previously identified precursors. In this embodiment, precursor detection and earthquake prediction are described with respect to the azimuth, arrival time, and horizontal phase velocity of the precursor. Nevertheless, the receiving station may not require all of the listed characteristics of the plane wave in order to identify precursors, and other characteristics of the plane waves may be used to identify precursors.

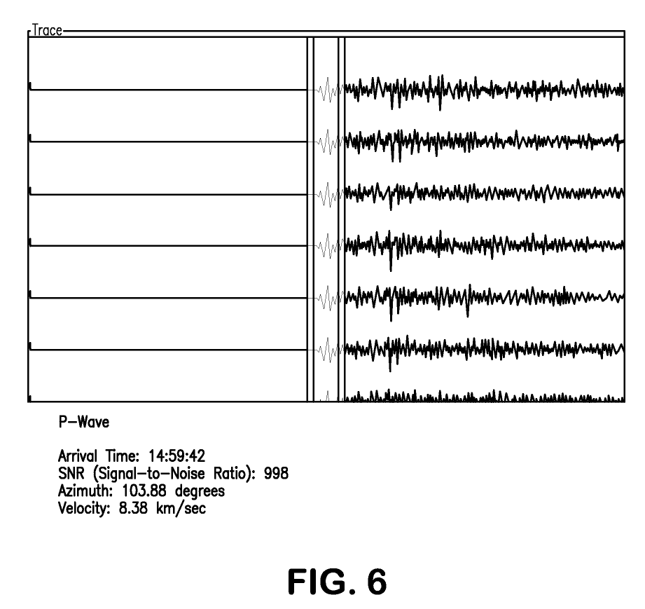

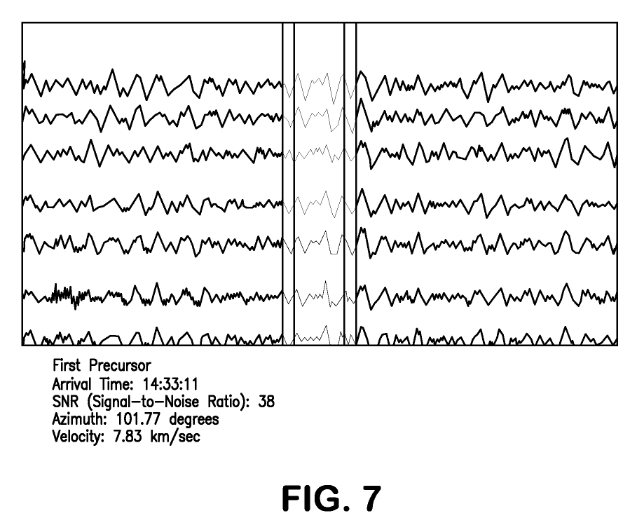

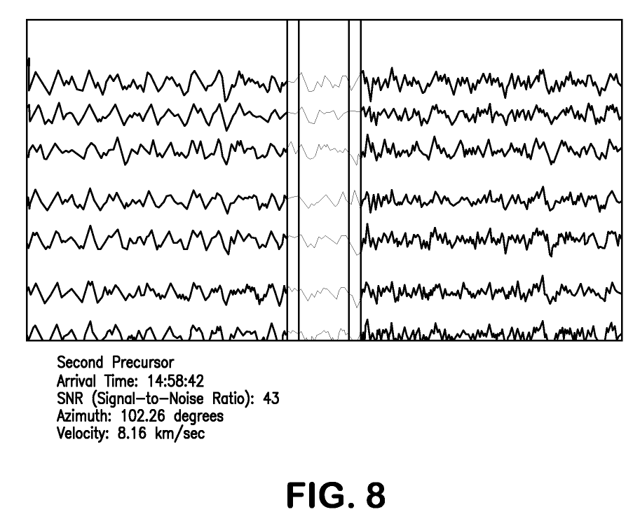

For example, the earthquake whose epicenter hit the Gulf of Mexico on Sep. 10, 2006, generated the P-waves illustrated in FIG. 6. These P-waves had a specific azimuth, velocity, and arrival time. This seismic event generated at least two precursors, e.g., seismic events with similar fundamental characteristics in the P-wave, but that did not generate an associated S-wave, and did not have sufficient energy to cause detectable surface damage. These precursors are illustrated in FIGS. 7 and 8. The first precursor, depicted in FIG. 7, was identified by the sensor array about twenty-six (26) minutes prior to the seismic event depicted in FIG. 6. The highlighted data points of FIG. 7 have similar wave characteristics to the highlighted data points of FIG. 6, indicating similar azimuth and velocity.

The second precursor, depicted in FIG. 8, was identified by the sensor array about sixty (60) seconds prior to the seismic event depicted in FIG. 6. As described above with respect to FIG. 7, the highlighted data points of FIG. 8 have similar wave characteristics as the highlighted data points of FIG. 6. Large seismic events in this region which may occur in the future, may have the same or substantially similar P-waves, and thus may generate the same or substantially similar P-wave precursors. By comparing data received by sensors 110 to previously recorded P-wave precursors, then seismic events of sufficient size to generate destructive S-waves, e.g., earthquakes, may be effectively predicted.

By calculating P-waves as described above, whether identified by the portable sensors and portable data processing module 130, or by a stationary data processor and stationary sensors, and by comparing the P-wave data to known precursor P-wave and earthquake P-wave data, precursors to seismic events, e.g., earthquakes, may be identified. This identification may be implemented at locations close to the seismic events, but data collected from locations remote from the epicenter of the potential major seismic event also may be used. These precursors may then be identified and used to predict major seismic events well in advance of the emergence of the major seismic event.

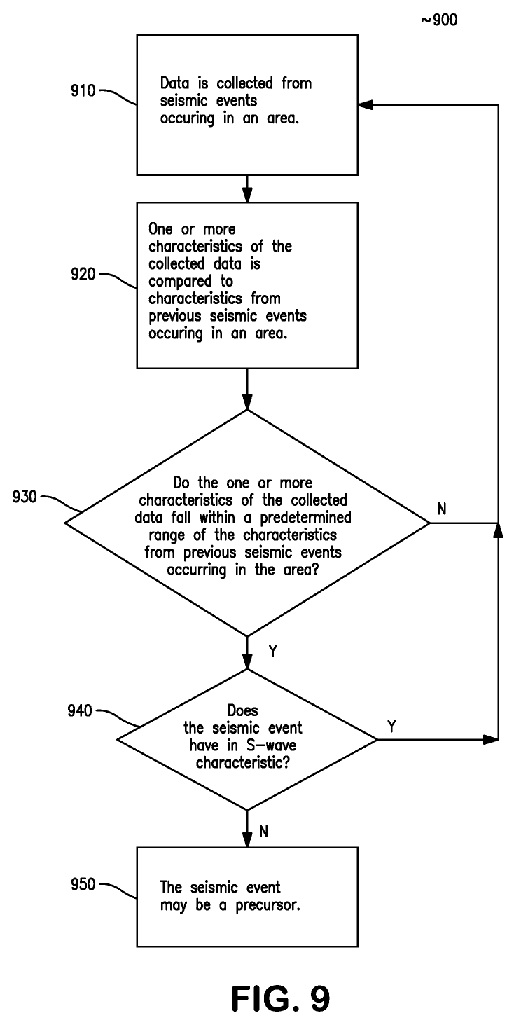

Referring to FIG. 9, a method 900 of identifying a precursor according to an embodiment of the invention is described. In step 910, data may be collected from seismic events occurring in an area. The area may be a specific predetermined area, or the area may be an area having high levels of seismic activity. In step 920, one or more characteristics of the collected data is compared to characteristics from previous seismic events occurring in the area. In an embodiment of the invention, the characteristics that may be used to compare the collected data to the previous data may be the horizontal phase velocity of the P-wave of previous seismic events, and the azimuth of the previous P-waves. This data, along with a high signal to noise ratio, may be used to identify seismic events that may be precursors.

In step 930, if the selected characteristics, e.g., the horizontal phase velocity and the azimuth, fall within a selected range of the collected horizontal phase velocity and azimuth data, then the method proceeds to the next step. Otherwise, the seismic event which may be generating the data may not be a precursor, and the system returns to collecting data from other seismic events. The selected range may depend on several factors including the availability of previous data, the signal-to-noise ratio of the collected data, and the particular characteristics of the area in which the data may be collected. Nevertheless, in an embodiment of the invention, a precursor identification may be within 4 degrees of the azimuth, and 4 km/sec. of the horizontal phase velocity.

If the collected data falls within the selected range, then in step 940, data is collected to determine if the seismic event has an S-wave characteristic. One characteristic of precursors is they may not have a detectable S-wave. Although S-waves are described in an embodiment of this invention, earthquakes and other major seismic events generate many waves which precursors may not have, and other waves may be used to determine whether a seismic event is a precursor. In step 950, the seismic event may be determined to be a precursor.

In another embodiment of the invention, data processing module 130 may analyze the received data by comparing one or more characteristics of the received data to characteristics generated by known activity. As an example, some seismic events, e.g., artificial events, such as underground demolition, or underground tunneling, may produce seismic data having characteristics which may fall into one or more predetermined ranges, e.g., a seismic signature. Data processing module 130 may compare received data to the seismic signature of known seismic events, which may allow data processing module 130 to detect different types of seismic events taking place. Data processing module 130 also may use time-based data tracking to pinpoint the origins of specific seismic events. In this manner, data processing module 130 may be able to covertly detect underground activity, such as mining, blasting, or tunneling. This process will be further described herein.

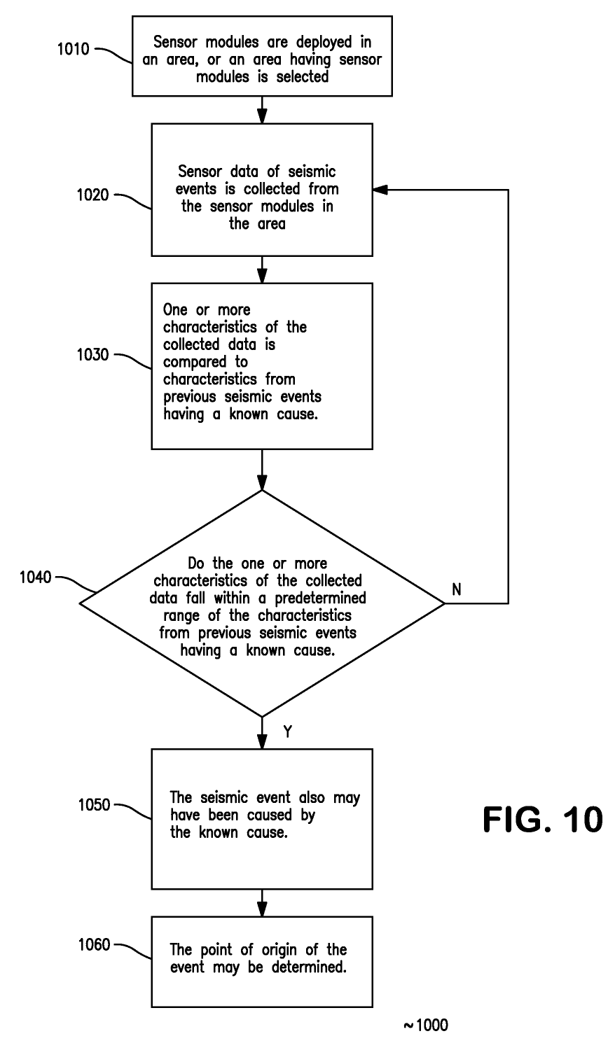

In an embodiment of the invention, sensor modules 110 may be used to detect specific events that may generate seismic energy, e.g., ongoing or completed underground activity. Referring to FIG. 10, a method 1000 of detecting seismic activity according to an embodiment of the invention is described. In step 1010, sensor modules may be deployed in an area, or an area having sensor modules previously deployed may be selected. If portable sensor modules 110 are used, then portable sensor modules 110 may be deployed in a target area just prior to detection of a seismic event. In step 1020, sensor data from seismic events may be collected from the deployed sensor modules. In step 1030, characteristics of collected data may be compared to data from characteristics of previous seismic events having a known cause, e.g., underground tunneling or blasting.

In step 1040, if the characteristics of the collected data are within a predetermined range of the characteristics derived from previous seismic events, then the method proceeds to the next step. In this embodiment, a seismic event generates seismic waves, which then would be detected by sensor modules 110, and transmitted to the other portions of the system, as described above. The selected range may depend on several factors including the availability of previous data, the signal-to-noise ratio of the collected data, and the particular characteristics of the area in which the data may be collected. If the collected data is within the selected range, then in step 1050, a determination may be made that the seismic event also may have been caused by the known cause which generated the characteristics for the comparison. If the data is not within the selected range, then the system may return to collecting data. Finally, in step 1060, the point of origin of the event may be determined, based on the collected seismic data, which may be collected over a period of time to allow time-based analysis.

While the invention has been described in connection with preferred embodiments, it will be understood by those skilled in the art that other variations and modifications of the preferred embodiments described above may be made without departing from the scope of the invention. Other embodiments will be apparent to those skilled in the art from a consideration of the specification or practice of the invention disclosed herein. It is intended that the specification and the described examples are considered as exemplary of the claimed invention, the scope of which is indicated by the following claims.

What is claimed is:

1. A system for detecting seismic waves comprising:
one or more sensor modules, each sensor module comprising:
a detection unit configured to detect a plurality of seismic waves generated by seismic events;
a positioning module, configured to determine the position of the sensor module;
a digitizer configured to communicate with the detection unit;
a radio transmitter configured to transmit digital data collected by the digitizer; and
a power supply configured to provide power to the sensor module;
a communications interface module comprising:
a receiver configured to receive digitized data from the plurality of sensor modules;
a data storage device configured to store the received digitized data; and
a data relay module configured to transmit the received digitized data; and
a data processor configured to receive the data transmitted from the communications interface module, wherein the plurality of sensor modules, the communications interface module, and the data processor are configured to function independently of their position, and to change positions independently of each other.

2. The system of claim 1, wherein the detection unit is a triaxial seismometer.

3. The system of claim 1, wherein the detection unit is a vertical seismometer.

4. The system of claim 2, wherein the triaxial seismometer comprises three sensors, and wherein at least one of the three sensors is positioned on each axis.

5. The system of claim 1, wherein the detection unit is selected from the group consisting of a seismometer, a hydroacoustic sensor, and an infrasound sensor.

6. The system of claim 1, wherein the digitizer polls the detection unit at predetermined intervals, and is configured to convert analog data from the digitizer into digital data.

7. The system of claim 1, wherein the communications interface module further comprises means for directly communicating with the data processor.

8. The system of claim 1, wherein the communications interface module further comprises means for communicating with the data processor through a wireless connection.

9. The system of claim 1, wherein the data relay module is further configured to receive information from the data processor.

10. The system of claim 9, wherein the communications interface module is configured to use the information received from the data processor to configure itself.

11. The system of claim 1, wherein the data processor is configured to convert the data transmitted from the communications module into at least one characteristic of the seismic wave movements.

12. The system of claim 11, wherein the at least one characteristic is selected from a group consisting of: a velocity of at least one of the seismic waves, an amplitude of the at least one of the seismic waves, and a direction of the at least one of the seismic waves.

13. The system of claim 1, wherein the communications interface module is positioned within about 45 kilometers line-of-sight of each of the sensor modules.

14. The system of claim 1, wherein the communications interface module is configured to store received data if the data processor cannot receive the transmitted data.
